(19) United States
(12) Patent Application Publication
(10) Pub. No.: US 2015/0066557 A1
(43) Pub. Date: Mar. 5, 2015

(54) System and Method for Tracking and Managing Mobile Resources

(71) Applicant: Tim Lichti, Washington, DC (US)

(72) Inventor: Tim Lichti, Washington, DC (US)

(21) Appl. No.: 14/525,470

(22) Filed: Oct. 28, 2014

Related U.S. Application Data
(63) Continuation of application No. 14/208,035, filed on Mar. 13, 2014.
(60) Provisional application No. 61/782,497, filed on Mar. 14, 2013.
(60) Provisional application No. 62/063,617, filed on Oct. 14, 2014.

(51) Int. Cl. G06Q 10/06; G08G 1/00

(52) U.S. Cl. CPC G06Q 10/06311; G08G 1/20
USPC 705/7.15; 701/517; 701/482; 705/34

(57) ABSTRACT

A system and method for tracking mobile resources that displays tracking data in a graphical display. The system receives tracking data and characteristic tag data about a mobile resource from a tracking device, which is stored in a server or sent directly to a reporting device. The reporting device creates a graphical display indicating, e.g., how long a resource has been at various locations and displays this information on a display device.

### RELATED APPLICATIONS

This application is a Continuation in Part of U.S. Non-Provisional application Ser. No. 14/208,035, filed on 13 Mar. 2014, which claims priority to U.S. Provisional Application Ser. No. 61/782,497, filed on 14 Mar. 2013; and U.S. Provisional Application Serial No. 62/063,617, filed on Oct. 14, 2014. All are hereby incorporated by reference in their entireties.

### FIELD OF THE INVENTION

The present invention relates to systems and methods for monitoring mobile resources and displaying tracking and other related information.

### BACKGROUND OF THE INVENTION

A need exists for a robust solution that tracks one or more objects or mobile resources, and presents information regarding their characteristics. Those characteristics include, for example, location data, amount of time spent at certain locations, tasks assigned, cost information, skills, etc. The current invention includes a system and method for displaying, among other things, location data and mobile resource characteristics (e.g., indicating how long the resource has stayed at a specific location). This system and method are also usable to assign mobile resources to certain tasks based upon their location, characteristics, and/or user or project requirements. The system and method can further be used to assign characteristic data to objects or mobile resources associated with tracking devices, which allows for compiling information databases, conducting statistical analyses, executing billing or invoicing functions, and managing resources.

### SUMMARY OF THE INVENTION

An embodiment of the present invention comprises a mobile resource management system having at least one tracking device associated with an object or mobile resource to be tracked. The mobile resources may be located anywhere in a building, city, region, state, or country, for example. The resources may be part of a governmental agency, such as an ambulance; a private contractor; or an internal company unit that has specific capabilities.

The tracking device communicates location data and other data through one or more networks to a server. The tracking device may include a housing that encloses a processor, a memory, a position locator, and one or more transmitters and receivers. Each of the latter components are electronically coupled to the processor. The transmitters and receivers may be adapted to send and receive voice and data signals in a digital format wirelessly or through a wired connection. The tracking device may further comprise a battery, a speaker, a microphone and a user interface electronically coupled to the processor. The user interface may be used to activate voice or data communications with the server. The tracking device may be capable of receiving and sending communications in any number of forms known to those of ordinary skill in the art, including, but not limited to, data transfer, facsimile, email, voice, SMS, and instant messaging, etc. The tracking device may further include one or more sensors for monitoring certain aspects or features of a particular object or mobile resource. For example, on a truck, the sensor could be used to detect the truck's rate of speed, lock or unlock status, door open status, weight, gas level, etc.

At a minimum, the tracking device communicates a unique identifiable signal or identifier and locational information, such as a global positioning signal, that is directed to a communications link (such as a satellite or wireless cell tower, a world wide web service, or an appropriate communication link that is connected to the server). Accordingly, the positional or locational information of each mobile resource is provided to the server instantaneously or at least on a periodically updated basis. The unique identifiable signal or identifier may identify the mobile resource, provide status information about the mobile resource (e.g., inventory), operating range and other characteristic information.

The server aggregates data provided to it by one or more tracking devices and stores the data in a memory as monitoring session data. The server may be connected to one or more devices or sub-systems, including, by way of example, a reporting device and a display device. The server (and associated devices) may be located or utilized by, for example, a call center, which comprises servers, networks, and various computer devices that are maintained by trained personnel. The call center may be accessible via traditional phone systems, wireless phones, wireless internet devices via the internet or other appropriate communication links.

The server may have access to a database structured to store various components or data, including, but not limited to pertinent information (e.g., characteristics) related to any number of tracking devices and/or associated mobile resources or data fed to the server by sensors integrated or attached to the tracking devices.

A reporting device may receive data from the server (including, for example, characteristic data, monitoring session data, or data from an external server) or from external sensors and use the data to create a graphical display, which may include a map, that can display some or all of the data (or visual representations of the data), including, for example, where object(s) or mobile resources are, where they have been, and where they have stayed for periods of time relative to, for example, the overall length of a monitoring session(s) or specified time period.

In another embodiment, the system can send messages including instructions to, or assign objects to tasks or locations, based upon object characteristic tags provided by the tracking device(s). The system in this embodiment can also send data to be displayed on the monitor of the tracking unit for the user to read and take action according to the message(s) received.

In another embodiment, the system obtains data from external inputs, such as sensors or databases, and presents the reporting device data on, e.g., a display, with location data concerning tracked objects. This embodiment can be used to determine, for example, the distribution or use of tracked objects. It can also be used to trigger the sending of alerts. The display device may include a personal computer (PC) or monitor, or other similar user-interface type device in communication with the server. The user interface may be directly connected to the server, or it may be linked by a network, the internet or dedicated telephone line, or other connection. Indeed, the server, the database, and display device may be integrated with one another and supported by a processor-based computer system. The system includes the necessary hardware, software and memory to implement the operations disclosed herein. The system includes a processor that is capable of coordinating all the activities of the server, such as routing messages and information, and creating alerts. Moreover, the processor coordinates access to the database, formats the contents of the database, and allows for changes, additions or deletions to the database records as needed.

In another embodiment, mobile resources or objects associated with tracking device(s) can log into the system or otherwise indicate to the server when they are or are not available to be, for example, tracked or available to receive.

Another embodiment of the invention allows for real-time updating of a display on the display device as data is received from tracking devices, or other inputs such as sensors or external databases.

In a further embodiment of the invention, data from multiple tracking devices are combined into a single monitoring session data set, from which a display is created by a reporting device and displayed on a display device. The display may include visual representations of the multiple tracking devices and a map.

Another embodiment of the invention allows for multiple objects or resources to be assigned to a single tracking device.

In yet another embodiment of the invention, the system can send alerts or notifications to objects or mobile resources tracked by tracking devices, or others (for example, the system can send alerts to the mobile phones of persons who are not logged in to the system but should be “clocked-in”). The system can also send alerts to other systems that are networked to receive such alerts, for example, in cases of high priority events.

In another embodiment, the system uses location and characteristic data to execute billing, invoicing or administrative functions such as generating invoices, tracking employee pay, monitoring employee locations, recommending when tools should be replaced or inspected based upon various factors (including the amount of time the tool was in use or number of uses), and presenting or recommending distribution of mobile resources or objects.

In a further embodiment of the invention, the system determines the efficiency of activities based upon various factors, including the time spent on activities, costs associated with activities, or when and where activities are performed.

In another embodiment of the invention, when different tracking devices are combined at a location, or grouped together though not at the same location, the system can assign a characteristic tag to the grouped devices and treat them as a single resource for purposes of, for example, sending instructions or tasks like dispatch to an emergency call, or monitoring movements.

In yet another embodiment of the invention, a tracking device can be an active transmitter or a passive recording device that will have location data recorded on it read by a reader and then provided to a server or reporting device for processing and/or displaying.

### BRIEF DESCRIPTION OF THE DRAWINGS

Reference is now made to the accompanying drawings, in which:

FIGS. 1 and 2 show examples of systems suitable for tracking mobile resources in accordance with various aspects of the invention.

FIG. 3 shows a flowchart illustrating an example method for tracking mobile resources in accordance with various aspects of the invention.

FIG. 4 shows an example display view in accordance with various aspects of the invention.

FIG. 5 shows a flowchart illustrating an example method for tracking mobile resources in accordance with various aspects of the invention.

FIG. 6 shows an example display when multiple units are combined into a single resource in accordance with various aspect of the invention.

FIG. 7 shows an example display of linked resources and resources that are linked with a task area, be they located inside or outside of a task area in accordance with various aspects of the invention.

### DETAILED DESCRIPTION OF THE INVENTION

Exemplary embodiments of the present invention relate to resource allocation, tracking, usage and related billing functions, route adherence and alert generation based upon the activities, contacts, locations or route of tracked resources. Although specific embodiments will be illustrated and described herein, it should be appreciated by those of ordinary skill in the art that any arrangement, which is calculated to achieve the same purpose, may be substituted for the specific embodiments shown herein. This application is intended to cover any adaptations or variations of the present invention that generally relate to systems, methods and an apparatuses regarding the exemplary embodiments below.

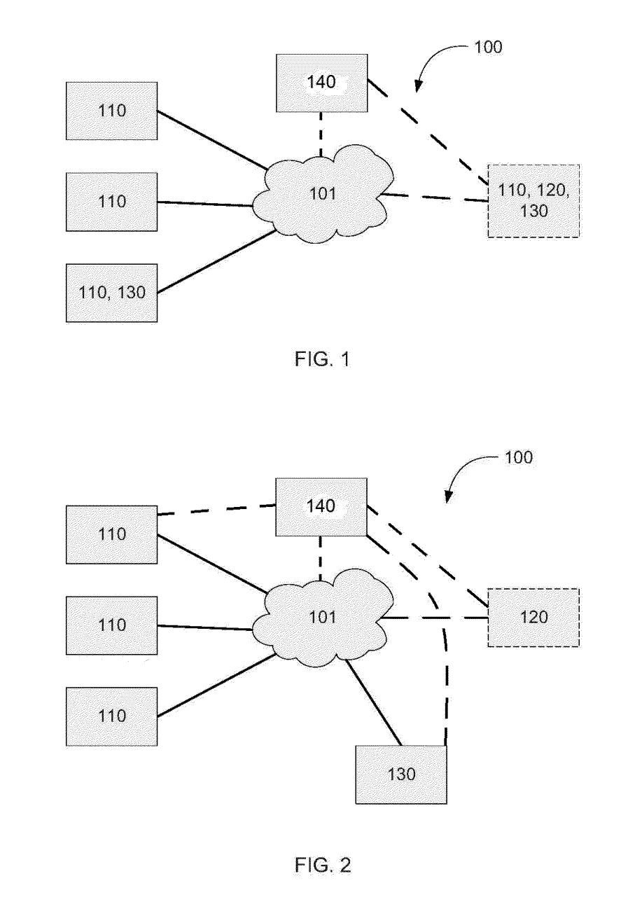

FIG. 1 shows an example of a mobile resource monitoring system 100 suitable for tracking mobile resources. System 100 includes one or more tracking devices 110. The devices are associated with mobile resources or objects, but can also be used for non-mobile resources as well. Each tracking device is associated with characteristic data or tags, and location information. The characteristic data can include information such as tasks, attributes of the resource, qualifications, abilities, physical characteristics, etc. Additionally, locations may have characteristic data associated with them. In some embodiments, tracking devices 110 may include mobile electronics such as mobile phones, pagers, mobile computers, tablet computers, cameras or vehicles with location and communication capabilities and the like. In some embodiments, tracking devices 110 can include RFID (radio-frequency identification) tags, GPS (global positioning system) tracking units, Automated Identification Systems (AIS), wired or wireless communication devices or other devices suitable for providing location information for tracked mobile resources.

A tracking device 110 can be associated with mobile resources or objects such as personnel, vehicles or pieces of equipment. It can in some cases be associated with non-mobile objects such as, for example, a checkpoint on a trail or a building. Each tracking device 110 can be assigned to a single item or to a group, such as a team of personnel or set of tools or people with specific levels of training or qualifications. In one example, a tracking device 110 can be stored, mounted, carried or otherwise positioned in close proximity with an associated mobile resource. For example, a tracking unit or mobile phone with tracking capabilities can be assigned to an employee or to a vehicle. Alternatively, a vehicle with a navigation unit can be programmed for two-way communication and meet the requirements for being a tracking device 110. Tracking devices 110 can also include RFID tags or GPS tracking units mounted to personnel badges, clothing, equipment or other objects generally positioned in close proximity or attached to a mobile resource. In some examples, a tracking device itself can be the mobile resource, such as for example, a mobile phone, laptop computer or a vehicle with a built in GPS tracking unit. The keys to the vehicle can have a separate tracking device attached or built into it. Many modern day vehicles use proximity sensors built into the keys and vehicle to determine when to unlock the vehicle, this same system can be incorporated into the invention and when the vehicle unlocks the doors, the keys and vehicle are reported as a resource and start a monitoring session. Data communicated by the tracking devices can include, by way of example, location information, battery life, fuel level etc. The combination resource of a vehicle key, vehicle tracking device and driver tracking device can be configured to report when that the vehicle is moving when the keys and/or driver are not located within the vehicle and to have the system transmit an alarm while continuing to monitor the position of the vehicle. Each of these can use different communication methods, such as WiFi, BlueTooth™, cellular data networks or hardwire connection, or other communications media to establish connections to the system. When a single tracking device 110 is assigned to a group, it can be maintained by any component of that group. The officer in charge of a fire engine may have a tracking device built into his radio that he carries, his personal ID tag, or his firefighter gear (e.g., a Scott Pak personal locator device used by fire fighters with a transponder built into it). The tracking device 110 could be used to indicate that a fire crew associated with the officer or other personnel or equipment is available at his location. This “crew” could include the officer in charge and a minimum number of firefighters and a fire engine. The system can compile and indicate a team is ready when it receives tracking device signals from each of the team members that indicates they are within a certain distance from each other or at the fire house, which is a task location, and are on the clock. This can be accomplished, for example, by having RFID readers at each entrance/exit that scans each tracking device as the enter or exit the fire house. The system can then combine all of the monitoring sessions for each tracking device into a single session with a characteristic tag indicator that indicates the team is available. The team would maintain the characteristic tag until some or all of them went off the clock or otherwise departed from a particular location, for example.

Alternatively, a number of tracking devices with specific qualifications can be used to generate characteristic data or a tag for all the tracking devices involved. One example may be a police SWAT team truck where all of the SWAT personnel carry a cellular telephone as their location tracking device. When, for example, at least six SWAT team members (each associated with a tracking device with the “SWAT” characteristic tag), and one SWAT team captain (associated with a tracking device with the “SWAT team captain” characteristic tag) and one SWAT driver (also associated with a tracking device, with the “SWAT driver” characteristic tag) are located within a certain distance of the SWAT truck (itself associated with a tracking device and tagged as a “SWAT truck”), the system generates a “SWAT Team” tag. The tracking device in the SWAT truck may be capable of direct wireless communication with the other tracking devices within its area, such as a mobile, encrypted cellular Pico or Femtocell with a list restricting users to only those tracking devices that have the SWAT characteristic tag. When the appropriate tracking devices with the SWAT characteristic register with the Femtocell, the Femtocell can report the team has been assembled. A SWAT unit may be shown as available on the system and related display devices for assignment by a user or dispatcher, such that the entire team can be monitored, instructed, or assigned tasks at one time and those others who have the SWAT characteristic tag (but are not registered as part of the team), do not receive the “SWAT team” characteristic tag. A similar setup can be used with any radio that is capable of camping and registering on a wireless network such as Wi-Fi, programmable radios etc., where the base station/radio communicates directly with the resource components and then reports back to the server/dispatcher/user. It can also be accomplished where any of the tracking devices has the capability of communicating with the other tracking devices to account for their location(s) and report them to the system.

Location and characteristic tag data from tracking devices 110 can be communicated to one or more reporting devices 130 and/or one or more servers 120 via network(s) 101. Network 101 can be any data network sufficient to transport the data required for operation of the system. More than one server 120 can be networked to communicate with each other and other devices, such as tracking devices and reporting devices. A network 101 can include one or more public and or private networks, e.g., a private or public telecommunications network such as the internet, or a Virtual Private Network (VPN). The network 101 can include wireless networks such as cellular telephone networks, Wi-Fi networks, satellite networks and wired networks such as standard Ethernet or coaxial cable sections and the like. The network 101 can include RFID scanners, Bluetooth™ devices, near field communication (NFC) devices, or other devices for detecting, scanning or otherwise communicating with tracking devices 110. The network can be a combination of any types of networks, or can use different networks for different types of communication.

A server 120 can receive and store location and characteristic information in an associated memory (not shown), and any information from sensors that the tracking devices may be connected to, or data from external databases 140, the server 120, or reporting device 130.

The server 120 and/or reporting device 130 may also communicate information to a tracking device 110. In one example, a server 120 responds to reporting devices 130 by requesting location, characteristic, or identifying information. The server 120 and reporting device 130 can be the same unit or piece of equipment that can accomplish both tasks. These can be co-located or located separately.

In some examples, the server 120 can be a computer, a computer server, a mobile computer, a tablet, a mobile phone or any other suitable data storage and processing device.

A server 120 or reporting device 130 can request location information or other characteristic data associated with a tracking device from tracking devices 110. A server 120 or reporting device 130 can also send information to one or more tracking devices 110.

A reporting device 130 can be a computer, a mobile phone, a tablet, a mobile computer, or any other suitable device.

The reporting device can include or can be connected to a display device or other means for displaying location information to a user, such as a user-interface. In some examples, server 120 or reporting device 130 can request characteristic or location information from one or more tracking devices 110 and thereafter display the information to a user on a display device, such as a computer monitor. In some examples, the reporting device 130 can also itself be a tracking device 110 associated with a mobile resource.

The system can also ingest information from external networks or databases using external inputs 140 through a data connection, a public or private network, or other connections as shown in FIG. 1 and FIG. 2. A connection to external input 140 is optional and can be used in any configuration of the system. There can also be a direct connection to a database from reporting device 130, server 120, or tracking device 110. There can be multiple databases 140, but FIG. 1 and FIG. 2 demonstrate an embodiment with a single database connected.

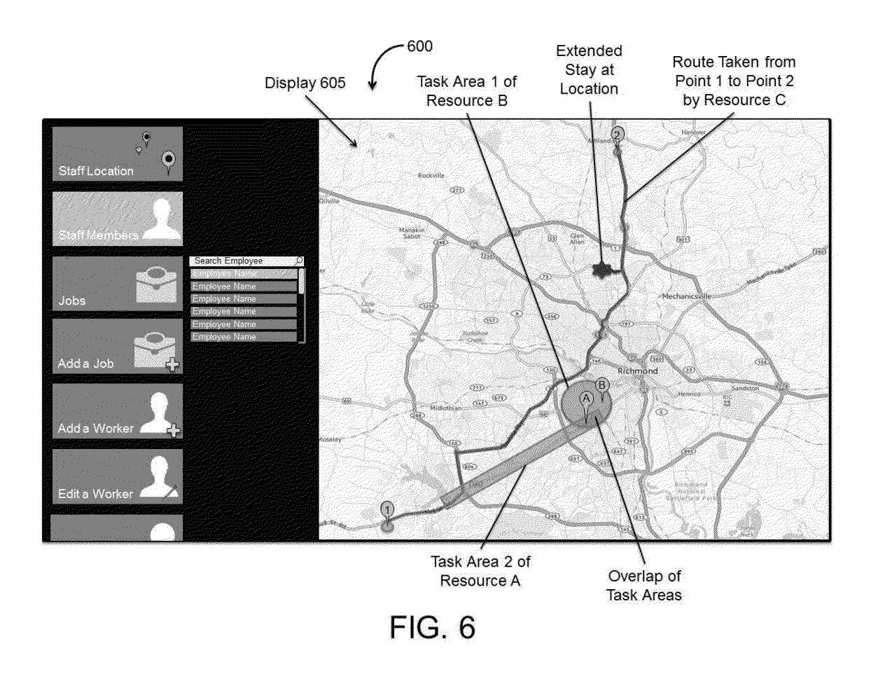

In one embodiment, the system automatically logs in objects or mobile resources (or otherwise tracks or monitors objects or mobile resources and displays location and/or characteristic data associated with the user) when they enter an area that is an assigned task area, as displayed in FIG. 6. When resource B enters Task Area 1, for example, it is automatically logged into the system, and when it leaves, it is noted as outside the task area and can be automatically logged out. This can be modified such that resource B is only monitored at those times resource B is to be working (inside or outside the task location).

Alternatively, a user of a tracking device 110 can log in or otherwise report to the system that the resource is available. This is especially useful for tracking billing for mobile resources who are “on the clock” but do not necessarily go to a specific location to work. For example, a police officer may be on duty as soon as he is dressed, and this may be at home or the police station. Likewise, an officer may be done with his shift and traveling home, but this time should not be counted as “clocked in,” even though he may traveling the same roads as he is assigned to patrol. This feature can also be used for comparing when a mobile resource should be on the clock, and the time they actually log in. The system can further send a text message, audio notification over the radio, e-mail, phone call or other communication to a tracking device or communications device associated with the tracking device when the resource is scheduled to start work at a certain time, but does not log into or otherwise activate the system (by, e.g., entering a task area or reporting for duty). For example, an officer may be scheduled to start working at 9:00 am. If by 9:10 am the officer has not logged into the system, the system can prepare and send a communication such as a phone call to his home phone, or a text message to his cellular phone, a page to his pager, or a message over his radio asking why the officer is not logged in, or otherwise notifying the officer of his tardiness. The system can also automatically send a notification to the officer's manager or supervisor, indicating that the officer has not “clocked-in” by a certain time.

The frequency which a mobile resource like an officer is on-duty (or “clocked-in” to the system) can also be tracked over time by the system to determine, for example, compliance with working hours or the like over a given period of time (e.g., a year). The system can then compile such data for multiple mobile resources and generate reports using a reporting device concerning, e.g., underperforming resources or if certain resources are consistently working overtime to reallocate shifts.

In some examples, as illustrated in FIG. 2, a reporting device 130 can be any device that can connect to a server 120 and/or to one or more tracking devices 110. For example, the reporting device 130 can be any device having a processor and a memory, and running an application or web browser that can connect to the server 120 or a tracking device 110 via a network 101 to process the data and send it to a display. The display can be physically a part of reporting device 130 or a separate monitor or the like.

In some examples, one or more of the tracking devices 110, servers 120, and reporting devices 130 can include processors, communication modules, storage media, and/or other components. They can also be a single unit that can accomplish the tasks of more than one device, such as a tablet that conducts the functions of both the tracking device 110 and reporting device 130.

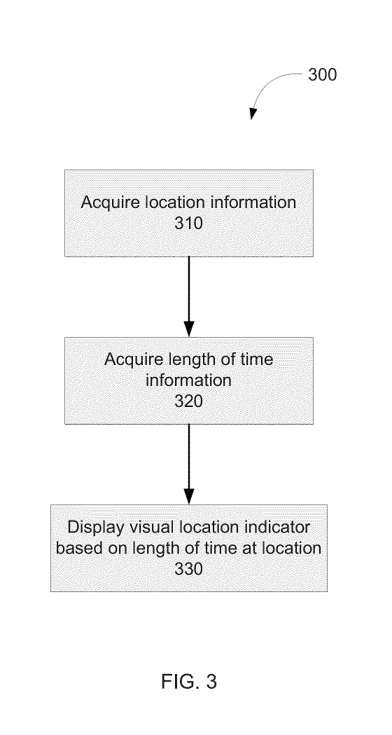

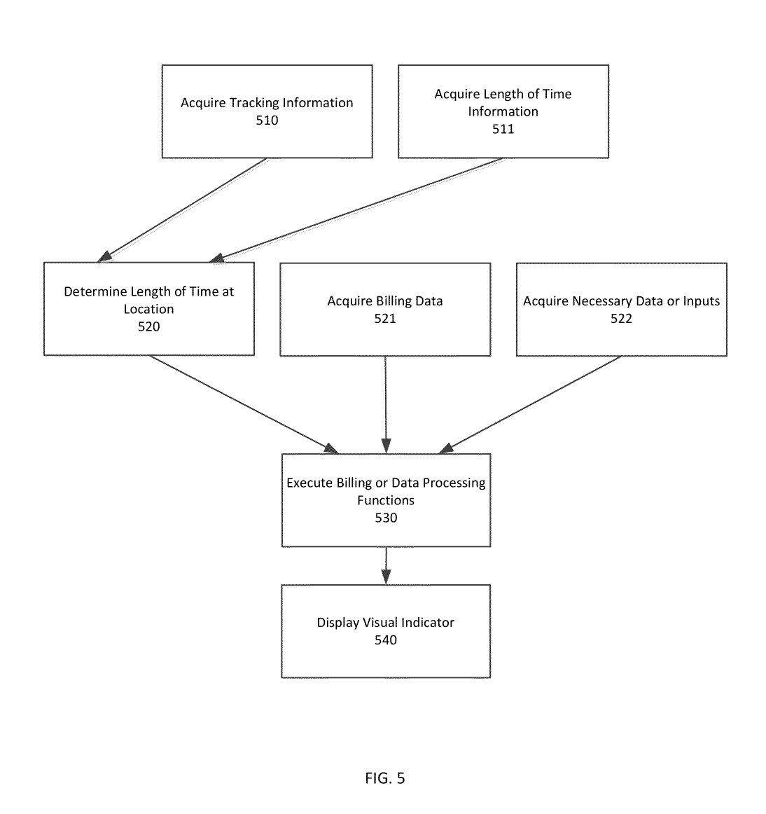

FIGS. 3 and 5 show flowcharts of exemplary methods for tracking mobile resources and obtaining information in connection with those resources.

FIG. 3 displays a method of tracking time at a location by acquiring location information from a tracking device, acquiring length of time information (be it, for example, from the tracking device itself or calculating from data obtained or stored by the system concerning time spent at a particular area) and then in step 330 displaying the results. It may be necessary for the system to calculate the time spent at a location if such information is reported by periodic RFID monitoring. In this way, the system begins the time when the first reading is taken and then continues while the tracking device is located in the area by the RFID monitor. This can also be necessary if a total time spent at a location is necessary and the resource leaves the area and then returns to the area.

FIG. 5 demonstrates how system 100 can be used to acquire tracking device information and associated characteristic data from step 510. Timing information 511 can be obtained from the tracking device or from other devices, such as the internal clock of the server or any other standard method of keeping time. This information is then combined in step 520 to determine the time spent at a location and has the associated characteristic sub-time frames, such as if the resource worked on two different tasks during a monitoring session. Steps 521 and 522 then bring to the system any data that is required to execute processing of the data for step 530, such as dispatch logs, or temperature data from the location tracking device itself, or historic data from previous tasks stored on a database connected to server 120 or reporting device 130. Data can also be manually entered in step 522 if necessary. Step 530 can also combine multiple monitoring session data to conduct any necessary processing prior to passing the data to step 540 for display. The information displayed can include, for example, any combination of current location, previous location(s), length of time at a location, characteristics associated with the mobile resources, billing functions, or any tasks or task areas associated with the resource. Each location or task or area can have characteristic tags associated with it as well, which can be processed in the same way as tracking device characteristic tag data.

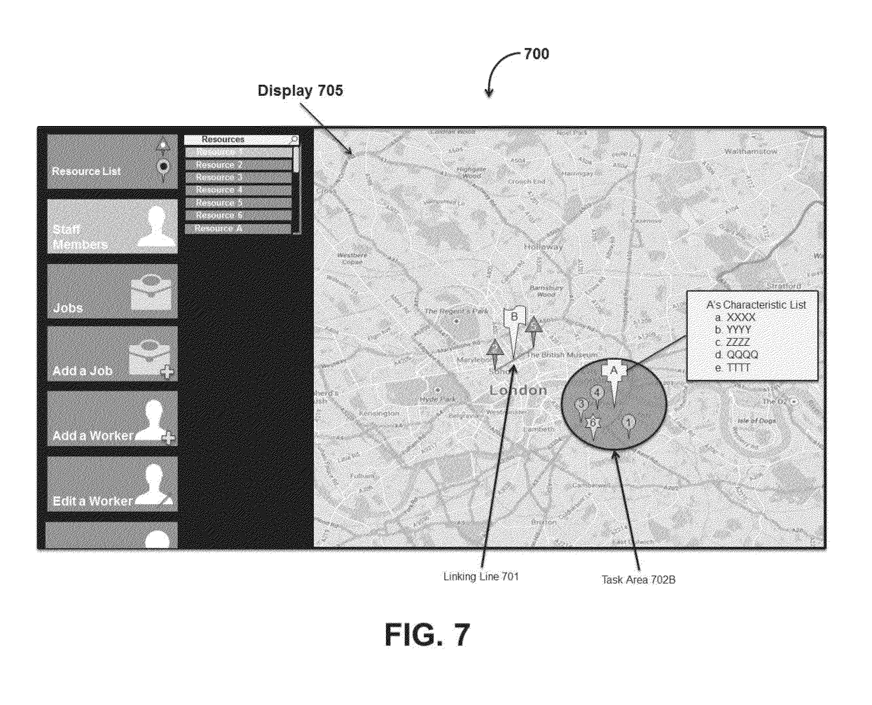

FIG. 7 displays alternate ways of displaying information concerning multiple resources associated with tracking devices on, for example, the display device associated with reporting device 130. Resources 2 and 5, for example, are linked and indicated by a line 701. Alternatively, the multiple similar or associated resources can be indicated by using the same pictures or icons, such as the triangles shown representing mobile resources 2 and 5. In FIG. 7, there is shown an icon indicating linked resources 2 and 5 to create combined resource B. For resource B, it can be indicated by only displaying tracking device 2 or 5 or B at a task location or the midpoint or other reference point to resources 2 and/or 5. Alternatively, resources can automatically be linked when they come within a certain proximity of each other, or when the resources enter a particular task area. This latter example is illustrated by resources 1, 3 and 4, assigned to Task Area 702B, thereby creating combined resource A. Prior to becoming linked to one another to form combined resources, resources can be shown using different icons or visual indicators, such as a square, and upon entering a task area or coming within a preset proximity of one another, the icon can change to something else. Once they enter the task area, the resources are assigned to and obtain a characteristic tag of a new combined resource. The individual resources, for example, can maintain their original indicator, or they can all be changed to the same indicator, or the system can automatically assign a new indicator associated with the combined resource. Similarly, if a new type of resource is created by the combined resource, icons or indicators can automatically be assigned by the system. Of course, icons or indicators may include shapes, letters, colors, numbers, or any other suitable indicator. In FIG. 7, resource 6 is not assigned to Task Area 702B, and therefore maintains a different icon and is not linked into Resource A (indicated by the cross containing a letter A), which resources 1, 3 and 4 combined to create. Combined resources, such as 1, 3 and 4 in FIG. 7, that make up Resource A can automatically or manually have their indicator changed such that all resources have the same indicator shape, but may have different colors to indicate different characteristic tags. Alternatively, a color can be the same and the shapes can indicate different characteristic tags. For example, a mobile resource representing the foreman of a construction site may be shown in one color, while the others (construction workers) are shown in another.

In some instances, characteristic tag information can include GPS coordinates, such as from a GPS receiver or GLONASS receiver, and can be any format to include MGRS coordinates, latitude and longitude, etc., it can also include information regarding wireless access points or communication devices to which a tracking device is connected, or information regarding a detecting device near which a tracking device was most recently detected, such as the coordinates of the cellular towers that most recently triangulated a tracking device and the location of the device itself.

The length of time at a location can be based on a duration of time a tracking device is stationary, or is within a defined distance to a particular position, location or centroid. In some examples, the length of time at a location can be based on a duration of time that a tracking device is connected to a specific wireless access point/sensor, or a duration of time between when a tracking device is detected by a first detecting device until the tracking device is detected by a second detecting device.

With reference to FIG. 5, system 100 can be used to determine a length of time a mobile resource spends at a location 520. In some examples, the system combines location and length of time information and then uses it for further calculations. For example, when a tracking device 110 is at a first position and moves within a threshold distance of the first position (e.g. 10 meters), the tracking device can be determined to be located at the first position for the entire duration of time in which it is moving, but stays within the defined distance of the first position. This area within a certain distance of the of a point can be marked as a task location. If the tracking device is anywhere within the confines of the task location the system can be continue to run billing functions (such as billing for the resource's time and, for example, electricity used in that location, and add those amounts together to procure a bill or invoice).

In another example, a tracking device 110 is located initially at a first position, and after a defined period of time (e.g., 1 minute), the tracking device is located at a second position within a threshold distance (e.g., 3 meters) of the first position. The location of the tracking device for this period of time can be determined to be at a single position and reported by the system as length of time at a location 520. Similarly, if after a second defined period of time has elapsed, the tracking device is moved from the second position to a third position within a threshold distance, the location of the tracking device for the entire period of time (from when to the tracking device was at the first position until the time when the tracking device was at the third position) can be determined to be located at a single position and reported by the system as such.

When a distance from a point or a region is used, if there is a second position nearby (such that the area of the two positions partially or fully overlap), the system may determine which position each tracking device is associated with, automatically. From that data, the system can conduct billing and statistical processing based on information and characteristic tag(s) of the tracking devices, and record the data to a monitoring session, automatically. Alternatively, a prompt can be raised by the system to a user, either the mobile resource who has the tracking device or a user viewing a map display, for example, requesting that the user designate which, if any, jobs, tasks, or billing matters to associate with the mobile resource.

For example, if one mobile resource associated with a tracking device (like a police officer) is assigned to patrol a specific city block, but another officer is assigned to patrol the main avenue that passes through first officer's duty location, or is assigned a region within the city that borders or overlaps partially or wholly on the first officer's assigned area, the system can monitor both resources. Alternatively, if the same location requires two different mobile resources, each with different skillsets or certifications, such as a plumber and an electrician to work on the same project, the system can automatically bill each resource at a different billing rate for their respective tasks at the same location, even though their task areas overlap (or prompt a system user to assign each resource billing characteristic tags or different tasks).

In some examples, location information, lengths of time, and associated characteristic data for one or more mobile resources associated with tracking devices can be compiled and stored at the tracking devices themselves, one or more servers, one or more reporting devices, or any combination thereof.

Location information can be displayed as a visual location indicator on the display device of one or more reporting devices based on, e.g., the length of time a tracking device has spent at one or more locations, or which tasks are undertaken at the location, characteristic tag(s) associated with the tracking device, or any other information such as information imported from an external database. In some examples, attributes of the displayed location indicator, such as type, size, color, etc., are based on the length of time spent at one or more locations, or the indicator may show multiple indicators representing the number of tasks that have been completed at the location. The location indicator may be set to change color, for example, after set periods of time, such that the icon does not change until the mobile resource has stayed at a location for, e.g., more than ten minutes.

In one example, the visual indicator can be displayed as a highlighted area on a map corresponding to location information. In some examples, the longer the duration of time a mobile resource spends at a location, the larger the visual indicator. In one example, the longer the duration of time spent at a location, the darker or more intense the color saturation the highlighted area becomes. Colors, and/or shapes and/or sizes, etc., can also change based on length of time spent at a location, such as starting as green and changing to red as more time is spent at a location.

The system can also import information from external databases and display this information on a map or use the data for other calculations, such as for the billing or invoicing of tasks, or any other aspect of the system. These databases can include the National Oceanic and Atmospheric Administration's National Climatic Data Center's historic weather database, a corporate database, cloud storage database, external hard drive or one contained on removable computer readable medium, etc. This feature can be automated such that the system seeks, receives, and processes the data when the system requires the data, or requires an update. Alternatively, updates can be periodic, such as every six months, or every time an event or type of event occurs, or continuous, such as receiving continuous traffic updates to display on a map with the movement trace of a tracking device. Updates or information can also be manually entered by a user of the system or the mobile resource.

On a visual indicator map, task location figures can also be displayed automatically (by, e.g., ingestion from a database) or manually entered by a user. These indicators may show the location of a task. The indicators can be, e.g., two or three dimensional. An indicator or highlighting may show the perimeter of the work area in which a mobile resource would be considered to be “onsite”. The indicators may have certain characteristic tags associated with them that can be displayed on the map (or nearby) such as the physical dimensions of the perimeter, number of different tasks (if the location is associated with more than one task), the name of the building or location, a physical street address, GPS, or other coordinates of the location, etc. This information can be pulled in from one or more databases, including external databases, or information provided by the tracking device. A tracking device that leaves the perimeter could stop reporting as “onsite” and the system could stop accruing billing and recording work hours for that mobile resource, for example. Buffer settings can be set for allowing short time periods to pass while not in the perimeter, so if the resource returns within a set period of time (or if the tracking device goes from one task location to another, such as from the assigned task location, to a vehicle outside the perimeter and then returns to the original task location) the system may continue billing or recording hours. This may indicate the resource carrying the tracking device had to go to the vehicle for additional tools necessary for a task and never had an intent to leave the perimeter. This buffer period can be automatically calculated based on the monitoring session length, historic data, such as from previous monitoring sessions, data collected from outside sources such as speed limits and traffic data for roads (if going from one location to another) or it can be manually entered by a user of the system.

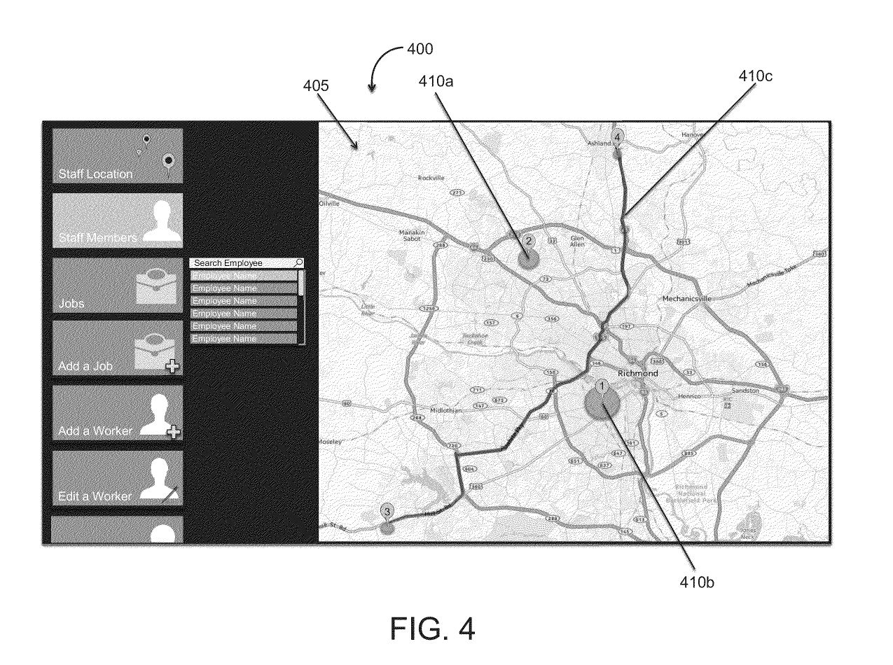

FIG. 4 illustrates an example display view 400, which can be displayed at or on a reporting device. Display view 400 can include a map 405 as illustrated in FIG. 4. In other examples, the display view 400 can include a building floor plan, a three-dimensional perspective figure, a blueprint, a globe, or any other view providing geographic or relative location information. If no map, figure, etc., is available, the system can display the movements of the tracking device and only display the overlay without the map. In this case, the system can provide a legend for distance and resize the display to show the mobile resources movements on the screen. The automatic resizing can be disabled if so desired by a user. In this way, this information can be saved to a file and a map created or provided to cartographers or others to create routes, maps, or figures of the area.

In the example view in FIG. 4, a first visual indicator 410a and a second visual indicator 410b are displayed as highlighted circular areas. A first visual indicator 410a illustrated at location 2 has a larger radius and area than the second visual indicator 410b illustrated at location 1. In some examples, the size of the visual indicator can represent the time a mobile resource carrying a tracking device spent at a location. For example, visual indicators 410a and 410b can indicate that a mobile resource spent more time at location 1 than at location 2.

While example visual indicators 410a and 420b are displayed as circles, visual indicators can be triangular, rectangular, spheres, tetrahedrons, cubes or any regular, irregular, two or three dimensional shape, for example.

In some examples, visual indicators can be displayed as three-dimensional bars or cylinders that have lengths corresponding to the duration of time a mobile resource spent at a location. Different icons, indicators, shapes or objects can also be used to communicate the duration of time spent at a location. This indicator can also display information regarding the location, such as traffic at the location at the time the tracking device was present.

FIG. 6 illustrates an example display view 600. It also contains a map display area 605, and a route taken from point 1 to point 2 by mobile resource C who is no longer in the map area or is “off the clock” for the time period that covers the monitoring session and therefore not shown on the display. On the display 605 or near it, there can be displayed the monitoring sessions timeframe(s). The display may also have visual indicators indicating an extended period of time at a location, such as a six pointed star in this case. FIG. 6 also displays Task Area 1 for Resource A and Task Area 2 for Resource B. These areas can overlap as can be seen on FIG. 6. Each task area can use different shading or colors compared to other task areas, overlap areas can also be automatically displayed in different colors or patterns. The color or pattern of a task area can be assigned based on the characteristic tags associated with the Resource A, or its tracking device.

In another example, visual indicators can include one or a combination of two-dimensional objects, three-dimensional objects, color, shape or size, changes of shapes, or any other visual indicator to indicate the length of time spent at a corresponding location.

The system can display different shapes for different time periods (e.g., if less than X minutes are spent at a location, a two-dimensional circle grows or, once X minutes have passed, a sphere begins to grow in the middle of the circle). The figures can change size from a particular point in time onward, and the indicators can be the same or different colors and can change colors, or if desired, as time passes.

Referring to the example display view 400 in FIG. 4, when a tracking device is in motion, visual indicators can appear as a path 410c.

The system 100 can be used within a small geographic area such as a building, or on a single floor, or even individual rooms, or part of a larger geographic area such as a hotel, a neighborhood, city, or country.

The system 100 is especially useful in tracking mobile resources who travel from their normal place of work (or whose normal place of work changes frequently). Such resources can include, for example, electricians, plumbers, and HVAC technicians who must go to various locations to render their services. These locations may be different floors in a building, or different buildings in a city, or across the world, depending on each resource's qualifications or duties. The system can track their location while they are “on the clock,” to ensure that they are at a particular location (or, conversely, that they are not charging for time onsite when they are physically not present at the worksite/task location). It can also be used to track mobile resources such as delivery personnel, including drivers such as a couriers, pizza delivery drivers, long-haul truck drivers, and others whose job it is to travel between different locations. Data from monitoring routes of travel can be used to determine, for example, which routes are best, which are slowest, and whether there are certain areas that should be avoided.

As illustrated for example in FIG. 4, display 400 can provide information on how long a mobile resource associated with a tracking device has spent at various locations. For example, a system 100 can be used to track remote personnel such as salespersons, police officers, or tradespersons. System 100 can, in some examples, be used to track employees within a building, such as doctor or patients in a hospital, cleaning staff in a hotel, or servers and/or managers in a restaurant.

In an example application for tradespersons, a manager or head contractor could use system 100 to provide visual information concerning where and how long an employee or sub-contractor spent at different locations based on the information provided by a tracking device associated with the employee or sub-contractor. In some examples, this data include the number of hours spent working or traveling, or whether too much or too little time is spent at certain locations (or traveling). In some examples, a display 400 can provide information that can be used to assign tasks to different mobile resources in a more efficient manner. This information, as well as the characteristic tag information, may be used by the system to create invoices for hourly rates or for resource costs. This can be done automatically. The system, for example, could access a database that maintains labor rates, hourly cost, or per mile cost for use of a piece of equipment. This kind of information can also be contained in the characteristic tags associated with the tracking device. Once the equipment is moved, or turned on, or checked out of inventory, the system records and creates billing data to add to an invoice. The system can further be configured to export this data or use it to create and send an invoice to a customer. It can also provide real-time updates of costs as they are incurred. This kind of information can also be manually entered or changed by a user, if necessary, to update, correct or make revise standard information. This could include, for example, special billing rates for a preferred customer.

For example, the system can determine the amount of time particular mobile resources spent in a geographical area over a period of time and generate various reports concerning these resources. System 100 can determine how much time mobile resources, such as police officers, spent in a particular neighborhood during the course of a month. Each of the officers can be assigned a “cost” (e.g., rate of pay, or other measure). Thus, if one Lieutenant is paid $30/hour and spent 20 hours in Neighborhood A last month, and one Constable is paid $50/hour and spent 10 hours in Neighborhood A last month, the system can calculate the total cost of police presence in Neighborhood A for the month was $1100 (the sum of the Lieutenant's $600 pay and the Constable's $500 pay). In addition, fixed costs, variable costs, stepped costs and other costs can be input (or programmed) and processed. For example, the fixed cost associated with policing Neighborhood A may be $100, for things like rent for police stations. Variable cost associated with policing Neighborhood A may be $200, for things like police cars and fuel. A stepped cost may be $50 to cover increased liability insurance that month. The system can then generate reports based upon this information. For example, if a certain neighborhood is calculated by the system to “cost” $20 million/year in police resources, but crime remains high, a request can be made for additional funding to dispatch more resources. This information can then be used to and compared with crime statistics to determine the effectiveness at preventing crime or predicting which routes or officer types should be used to have the largest reduction in crime for Neighborhood A at the lowest cost.

In a further example, a lawn cutting company may use the system to track a mobile resource associated with a tracking device who visits 10 different customers' lawns in a day. The tracking device regularly communicates the geographic location of the mobile resource via a network to a system server. When the resource arrives at the first site, the system tracks the mobile resource continuously within a radius of 200 meters for 30 minutes, the entire time the lawn is being cut. This data can be communicated to the business owner/manager, showing where the mobile resource was located and for how long. The system can also calculate job costs, by dividing the resource's rate of pay (e.g., $15/hour) by the time spent (e.g., 30 minutes), so the cost is calculated at $7.50 for labor. The system can further calculate job costs by considering the resource's benefits, pension and unemployment contributions, etc., vehicle costs, overhead, etc. to ultimately derive a total cost to the company for the job.

The system can continuously track the mobile resource from job-to-job. For example, if the mobile resource drives to a new job site, the system, sensing that the mobile worker has moved to a new location at minute 31, can stop assigning cost to the first job and begin tracking cost information for the second job. The system further provides for manually entering a list of job sites by a user, or manually assigning costs to particular jobs. This example also allows for calculating business overhead that is not normally assignable directly to a single customer, such as the costs for fuel for travelling between customer sites, say $200 in a week. This can be allocated in part to each customer and included on invoices such that prices for customers can be set to help cover these general expenses.

System 100 may further be programmed with various levels of permissions concerning which mobile resources are viewable, trackable, or assignable by a user. For example, a single dispatcher may only be permitted to view the 500 officers whom he/she is responsible for dispatching. A different person (for example, a city's police chief) could be granted higher permissions, to view all of the city's police officers, for example. Permissions can be assigned to individuals, groups, or in other ways, such as for a specific area. Certain permissions can also be set such that a dispatcher may be able to view two groups, but can only dispatch one of them (and would need to acquire additional permission or have an incident of a high enough importance rating to be granted permission to assign those resources).

System 100 can provide information regarding mobile resources other than personnel. For example, a display 400 can provide information on the travel patterns and waiting times of mobile resources such as vehicles, such as taxis, delivery or pickup vehicles, emergency vehicles and the like. In some examples, a display 400 can provide information on tools or equipment, such as mobile payment terminals, wheelchairs, or trolleys.

The system 100 can track a single object with multiple tracking devices within a single monitoring session, such as the key to a vehicle and the vehicle itself (making up a combined resource). Alternatively, two or more sessions for a single, or multiple tracking devices, can be combined into a single session automatically or manually by a user. During a single monitoring session, a single tracking device may be used, or multiple tracking devices associated with one or more objects can be used, and the data saved by the server for processing by a reporting device. Separate sessions can be initiated for each device and later combined by the server or reporting device. Each of the tracking devices can use the same or different location tracking or reporting methods, e.g. one tracking device can be a GPS transmitter, while another is a cellular telephone, and upon entering a building, the GPS unit may lose signal while the cellular telephone continues to operate. Going further into the building, an RFID tag that is capable of being read by Wi-Fi routes can take over or supplement the cellular telephone. Entering certain areas of the building may cause the cellular telephone to lose tracking as well, while the RFID continues reporting location. It is possible to lose communication with all three of these tracking devices and the system would indicate an unexpected termination of the monitoring session. If at a later time the system reacquires any one, some or all of the tracking units, the system could combine the apparent new monitoring session with the previous session into a single session. This way all of the data could still be used in a single monitoring session even if there is a gap in the data. When tracking devices are unable to communicate with the system, they they may track and record monitoring session data to local memory for later transmission to the server(s) and/or reporting device(s). The interface for a reporting device could provide the user the option to separate a session into multiple sessions, e.g. showing only the RFID, the GPS receiver or the cellular telephone tracking information, or any combination of the tracking units. It is also possible to split one monitoring session into two sessions (for example, one session for the time before all signal was lost, and another for when signal was reacquired), with or without an indication of how long tracking was lost.

The reporting device can be programmed to take action based on certain events. For example, if tracking is reacquired within a certain area of a loss of signal, monitoring sessions can be combined into a single session, such that if a cellular telephone is used as a tracking device and the user passes through a tunnel while driving and the signal is lost, or if the tracking device is turned off at a hotel (and turned back on the next day at the same hotel), the reporting device determines that the two sessions are a single session, or that the user stayed at that location for the period of time and combines them into a single session. Alternatively, the system can be set to allow a user to determine how to mark the time between the two sessions, for example, as time spent at that location or simply no data received.

Alternatively, the system can track the time it takes a mobile resource to complete a task at a particular location, such as the time it takes hotel workers to clean each room. The system can track the location of the hotel workers, each room being a separate task area, to determine how long it takes on average for workers to complete cleaning a room. This time can be set as an indicator on a display. If the employee takes less than an average cleaning time, a characteristic tag could be associated with her such that the employee can be recognized, be it by a pay bonus (which can be automatically calculated by the system), a letter of recognition, etc. Alternatively, if the employee takes longer than a particular amount of time, someone could be notified or an alert issued. The system can also use the average time it takes to complete tasks to assign the number of personnel that should be scheduled to work in a particular location. For example, the number assigned could be based upon the number of rooms that are reserved, and the size of the rooms. The time it takes to clean a room can also be linked to how many complaints are received regarding room cleanliness (or compliments on room cleanliness). The system could then be used to determine an ideal amount of time to clean a room to maximize customer happiness, or maximize hotel efficiency.

FIG. 7 shows an example of how the amount of time spent at a location (and other characteristic tags) can be displayed at or proximate to a visual indicator. For example, a time of day (e.g. 10 am, 5 pm) at which the tracking device arrived at a location can be displayed at or proximate to a corresponding visual indicator on a display, as well as other information such as a description of the mobile resource, qualifications, or resource characteristic tags. There can also be an option or menu, similar to the Resource List that displays a list of the characteristic tags of the resources. This can allow for sorting to display only those resources that have a characteristic tag, or excluding display of those that do have a particular characteristic tag.

Referring to the example display view 600 in in FIG. 6, different areas can be highlighted in different manners, such as by using different colors or shades, as areas assigned to specific mobile resources. Alternatively, borders or task area shading can correspond to different priority levels. For example, each incident, task or input that the system receives can be categorized or assigned a certain ranking of importance. A report of an automatic alarm in a warehouse may be classified as a level 4 incident, while a multivehicle crash a level 3 incident, a large riot is a level 2, and an earthquake level 1. These priority levels can be changed depending on the circumstances. A level 4 event (such as an automatic alarm), could be upgraded to a level 3 if it turns out to be a fire. The system can automatically update priority levels, or levels could be updated by a user or mobile resource through a tracking device or other means. For example, the system can sent out a notification of a level 4 event if a general fire alarm or smoke detector is activated, but upgrade the alarm automatically to a level 3 if the fire suppression monitoring system reports an activation of the sprinkler system. If an event with a particular level occurs, the system can send alerts to mobile resources not in the immediate area, such as those workers who are off-duty to be recalled to respond to the incident, even if they are not logged into the system at the time the event occurs. This overcomes the issue of people turning off their cellular phones or pages to avoid being contacted. The system can also send alerts to other systems via a network, such as a local emergency response system, by sending an alert to a state or federal agency notifying the agency of the incident and requesting additional resources if not enough mobile resources are identified by the system as in the area.

In another embodiment, task areas can reflect the locations a team is assigned to, e.g., door to door sales, information distribution, or assigned patrol (for police officers or security guards, or the like). The task areas can also be event locations, such if there is a water main break or a parade route. In the water main break example, another indicator, or one already on the map, can be used to indicate on the display 400 the area that should be evacuated, or is in the greatest danger from the event. The system can dispatch the closest appropriate resources, such as volunteers or police officers, to evacuate people from that area. These resources can also be assigned based upon their area of responsibility, such as if an incident occurs in Task Area 2 of FIG. 6. Even though Resource A may be closer, Resource B can be automatically assigned to respond because it has particular characteristic tags required to address the event. Alternatively, the system can assign any resource meeting particular requirements, regardless of the resource's location, based on characteristic data. A decision by the system as to which unit to dispatch can be based on any information available to it, including, for example, distance of resources from a particular location, characteristic tags of a resources reported by tracking devices, and event priority level.

Using imported (or programmed) data, such as from a crime statistics database, like the Federal Bureau of Investigation's Crime Statistics database and/or other location police department's database, the reporting device can further combine overlay display 400 with monitoring session data for a particular location to provide visual displays that can be used to effectively deploy mobile resources. The tracking devices can also be used to collect data, such as temperature or humidity, and transmit the data to the system for processing and/or display on a reporting device. Information can also be imported from databases outside of the system via a network or direct connection. The system can use this data to provide suggestions for better use of resources for more efficient outcomes. For example, the system can identify alternate travel routes for police officers, responding to a call, or different locations to place a cruiser for a “presence”. The system can also take into account the time of day, week, month or year, the temperature, weather or any other factors or variables, which can be processed by the system and used to make recommendations about mobile resource allocation in a particular location. The system can also provide recommendations for changes to resource allocation.

For example, the system could evaluate time spent by political campaign fundraisers in a door to door campaign in a task area. The system may calculate that best results are achieved when visits last at least 10 minutes, but no more than 15 minutes at each home in a task area (or best outcomes in a task area are achieved on overcast days, or that worst outcomes occurred on days where the temperature was 5 degrees below freezing). Resources can be allocated accordingly. Alternatively, the system can take into account that a political campaign fundraiser was conducted in a specific voting district with in a task area, and therefore, another campaign should not be run for a period of time. It can also indicate that certain regions should not be revisited because previous campaigns in the area have resulted in very low return on investment, and allocate resources to other areas that provide better return (e.g., by assigning them to a different task area). Alternatively, the system can generate Task Areas based on historic information to achieve higher rates of return on investment, based on parameters, such as, when the campaign is to be run. Likewise, the program can also track any individual or group of resource's success in any of the metrics above for a certain geographic area.

The system 100 including a reporting device 130, can also create visual “dashboards” such as bar graphs, pie charts, etc., to communicate information (e.g., a bar graph showing the average revenue generated per hour when a mobile resource canvasses a certain geographic area for the first time, for the second time, the third time, etc.). Alternatively, this data can be output to a file for later viewing or integration into other data sets.

The system can send alerts to tracking devices or display alerts to a user of a visual display 400. The alerts can cause the tracking device to take any number of programmed responses, such as, e.g., providing an audio, tactile or visual alert to a mobile resource. If the tracking device is a cellular phone, the system can utilize the handset's tactile and/or audio notification system to deliver alerts to a user. If the tracking device exceeds a specific period of time at a location, an alert can be displayed on the map, such as a flashing box, and/or the tracking device can sound an alert, be it audio, visual, and/or tactile such as vibration. These alerts can also be manually initiated by a user and sent to a tracking device to alert a mobile resource. Different kinds of alerts can be sent based upon the type of task, event, urgency of response, or priority level. This feature can be helpful in ensuring employees complete tasks in a particular amount of time (e.g., circuits of a security route or response to an emergency). Monitoring data could be aggregated and then provided as a report to insurance companies and/or homeowners to show a neighborhood watchman completed a certain number of tours, and passed by a specific location or house, for example. This information can be sent out periodically by the system, such as at the end of each week, or more or less often if desired. Combining this data (and an overlay of crime statistics during a time period) could be used to evaluate the effectiveness of a particular police patrol, for example.

While tracking personnel on routes, if there are delays on the route, the system can indicate to a user that something has happened and extra assistance (such as additional mobile resources) is necessary since the task is taking longer. The system can be preprogrammed to take actions such as sending alerts or dispatching additional assistance if for example, a resource remains at a location for more than a set amount of time. The system can also create a task or task area if resources with tracking devices keep congregating at a location or within a specific radius of a location. A task area, that does not previously exist, can be automatically created by the system if there is data that a threshold number of employees, which can be one or more, spend above a threshold amount of time within a specific distance of a single point. The centroid creation method can be used to create a task location, or other methods such as using the floor plan of a building to create a task location. This task area then allows a user to obtain information about what is occurring at the location, similar to any other created task area. Any details that are not automatically populated can be manually provided or later automatically populated.

In the example where the system is used to send an alert, the system can send the alert to a specific mobile resource based on location and characteristic tag information of the tracking device associated with the mobile device. For example, if there is a need for a police officer to be dispatched to a location at a specific address because of an alarm raised by a neighborhood watchman, the system determines which police officer with the required qualifications (based on the characteristic tag information of the tracking device) is nearest to the location of the event and sends the alert to the officer. The system can require an acknowledgement of the alert by the police officer (through the tracking device or other means, like a radio). Upon the officer beginning motion, or taking other actions, such as turning on the lights and sirens in his vehicle, the system can automatically begin accruing data (such as time it takes to respond, the route taken, and other pertinent data). Alternatively, the system can begin accruing this information upon receipt of an acknowledgement from the officer or on other pre-set conditions. In another embodiment, the system can send an alert to numerous mobile resources meeting specific requirements, who are closest to a location. If no one in the original group of resources who are a set distance away acknowledges the alert (be it physical distance or expected response time distance), the system can expand the alert to additional nearby resources until a resource (or an appropriate number of resources) responds, or a set distance is exceeded and/or time for response to the alert has been exceeded. The system can also inform a user that there are no available resources to respond to a location. If no personnel are currently logged into the system who meet certain qualifications, the system can also notify a user prior to any events, prompting the user to bring more particular resources “on the clock.” If a combination of resources is needed to meet a resource requirement, the system can send an alert to tracking devices having certain characteristic tags, and once all of the required resources acknowledge the alert, the system can notify the user and begin any necessary data collection and calculations. This can happen, for example, in a hospital where a patient is brought in to the emergency room requiring a trauma team consisting of a doctor, two nurses, and a physician's assistant, but only a trauma nurse is on the floor in the ER. An alert can be sent to other required resources in the hospital (progressively, beginning with those closest to the ER), e.g., a doctor located one floor away, a second trauma nurse, etc. As each resource requirement is filled, the system removes those alerts and indicates to the user that the team is complete and responding/working on the task. By selectively sending alerts to only required mobile resources, all resources are not distracted by irrelevant alerts. And by progressively alerting required resources beginning at a particular location and outward, the “closest” available resource is most likely to be assigned to a task.

Automatic follow-on alerts can also be sent by the system. If an ambulance is dispatched to a location, for example, but then leaves the location with its lights and sirens on, the system could notify the nearest hospital of the inbound ambulance and estimated time of arrival, and can update this time based on the real time data being processed as it approaches the hospital. The system can further allow user information to be input, such as the ambulance's payload information (e.g., the types injuries a patient has sustained). The system could also send specific alerts to the hospital team so the hospital can prepare for the arrival of the ambulance.

In another embodiment, once a patient is received in a hospital, the patient can be assigned a tracking device, such as one integrated into a patient identification wrist band. The system can monitor the location of the patient. It tracks how often and when the patient is checked by hospital staff (by, e.g., noting the entrance of another tracking device associated with a doctor in a patient room), so that each time a nurse does rounds, the system notes there is no need for the nurse to enter a particular patient's room, because the system updates this information in real time. The system can also integrate patient monitoring equipment, such that each time the patient's blood pressure is taken (be it by a nurse or automatically) it is logged into the system. The same data can be tracked for medications that are provided to the patient. The data can be logged into a patient file (as well as used to develop billing items and invoices for the patient or insurance). Alternatively, if a patient is in an isolation unit, the tracking device can be used by hospital staff to monitor and evaluate decontamination procedures. For example, if a care provider departs a patient room and enters a spray down area and they are required to stay in that location for a set period of time, the tracking device can monitor this and alert the staff when the procedure is not followed, or notify the user by an alert that they can continue on if appropriate procedures are followed.

The system can automatically update resources when combinations of components are altered. For example, a situation such as a motor vehicle collision may require dispatch of a paramedic and a basic ambulance to a scene, the paramedic ambulance having two paramedics and the basic ambulance having two EMTs. Upon arrival, it is discovered that two patients must be transported to a hospital, both requiring care by a paramedic. The crews may mix such that one of the two paramedics replaces a member of the basic ambulance, so that each unit now has a paramedic onboard. Both ambulances are noted by the system as paramedic units with a single paramedic (since each of the four first responders and each ambulance units contain tracking device with different characteristic tags). The combinations of the components will create different resources automatically as they are re-combined. This also allows for the system to automatically update billing data, for example, such that both ambulances will be bill at the paramedic rates as opposed to a basic ambulance rate. The system can also notify hospitals that the paramedic ambulances are headed their way, or to notify the paramedics, prior to their departure from the incident scene, which hospitals can accept the patients with the specific types of injuries or the nearest specialty unit (and the best route there, such as route 410c displayed on FIG. 4). Once both members of the paramedic crew return to their original unit and the EMTs to their original ambulance, the system could automatically update the status of the units.

The system can also track resources that are necessary for a single combined resource to be created. This can also be achieved by filtering and displaying only tracking devices with specific characteristic tag information. The system can filter out some location information before visual location indicators are displayed. For example, to provide only “current location” information, any location information from yesterday or earlier can be filtered such that it is not displayed as a visual indicator. Alternatively, a display can be set to only display resources with certain characteristic tags. In this way, individual components that make up a combined resource can be displayed, or displayed with different indicators. The system can also display all units that could make up a single combined resource (even if the resource requires fewer than all the inputs). For example, if there are 12 officers and one captain and two SWAT trucks available, and a single team requires seven officers, one captain and one truck, the system can display all 15 mobile resources, but once a SWAT unit is needed, it can display only the resources that are part of a combined resources, e.g. the seven officers, captain and the truck (and not display the other officers, captain or truck). Alternatively, the system can display the other officers and truck as “regular” officers and a police vehicle, and update characteristic tags to match, until enough other resources are available to make another SWAT unit combined resource. While a whole SWAT unit cannot be created, the system can still maintain the qualifications of the individual officers such that if special qualifications are needed, they can still be called upon, e.g., if an injury to one of the officers on the SWAT team occurs, or a need for more manpower with SWAT qualifications occurs, these individuals can be dispatched. In another example, a filter can also be applied to location information on a display when a tracking device is moving over defined speeds, or over defined distance thresholds, in order to not display visual indicators for when a tracking device is moving to a different site.

In a further embodiment, the system can also be used to track mobile resources with particular characteristic tags, such as sick patients. The system can further identify who else those resources have come into contact with, and for how long. For example, health officials or governments can use the locations of patients provided by tracking devices to see where infected, or potentially infected, people have traveled. Alerts can be provided whenever someone who is identified as infected or potentially infected comes within a geographic radius of another person, e.g. within 20 meters or 100 meters. The system can further measure the time a patient was in close proximity to non-infected persons. This embodiment can be combined with other systems that provide external information, such as security surveillance footage from video feeds like the city of London's Domestic Surveillance program, to identify people or resources that do not themselves have location tracking devices in order to calculate the number of persons exposed to a particular patient. This embodiment may also be used to notify those people who may have come into contact with the patient by sending alerts to those who may have potentially been exposed and providing information or directions on precautions to take. This method can then continue to notify everyone else who comes within a certain distance and/or spends a certain amount of time with the patient. Health care personnel or the Center for Disease Control (CDC) and other appropriate authorities or personnel may further be notified.

In one embodiment, anyone who is arriving in a low-risk zone from a high risk zone, for example, a health care worker arriving in USA from West Africa during an Ebola outbreak, may be asked to log into the system and activate a tracking device so that the system can monitor their location and contact with non-infected persons. The non-infected persons may also have tracking devices. The system can also be used to require a health care worker to activate the tracking device upon arrival in the high risk zone and maintain it until return and then a set period of time afterward return from the high risk zone (e.g. a quarantine period).

The system can further be used to predict the statistical likelihood of various persons being infected with a disease after having been in contact with someone who is a confirmed or likely infected patient. For example, analysis may show that historically, people who are within 20 meters of an infected person for 4 or more hours of time have a 2% likelihood of becoming infected. People who are more than 20 meters away from an infected person, or only within 20 meters of an infected person for 5 minutes or less, have a less than 0.01% likelihood of becoming infected. Alerts can be sent to health or government officials when the likelihood of infection reaches a certain threshold. Reports can also be created that indicate the likelihood of infection. The system can further be used to gain insights into what factors are most likely to contribute to the spread of an infection. For example, an infected person may have visited a mall. The system determines that a person came within 20 meters of 2,000 people during that trip, while having flu-like symptoms. Three people were subsequently infected, but all three were people are identified by the system as having been in the same store where the initially infected person vomited unexpectedly. Health officials may analyze this data and make determinations, for example, that the risk of infection through proximity to vomit is a much higher risk factor than urine, perspiration or airborne through respiration or other methods of transmissions.

An example of the method for tracking the spread of a contagion or disease using the method of the system could include the following steps. A mobile resource with a tracking device, comes within a certain distance of a location or other tracking device. The tracking device sends updates of its location to the server as it would normally. The server receives these notifications and records them in memory. A reporting device updates a visual display with each update. Upon the reporting device receiving a notification that a tracking device entered a high risk area, a hazard area or exposure zone can be associated with a location or resource or a characteristic tag assigned. The reporting device can obtain from a database or memory thresholds for determining if a notification is to be sent to the mobile resource. Prior to sending a notification to the tracking device, the system can check if the tracking device has one or more characteristic tags that would negate the necessity of sending a notification, such as if the tracking device entered through an authorized check point and by doing so, has a characteristic tag indicating they are wearing protective clothing. If no counter-indications for a notification exist, or if exposure criteria are met, the server sends a notification to the tracking device that it has entered the exposure zone or that it has been exposed. A hazard area or exposure zone can be a set distance from an object or a task area associated with a location. The system records the exposure information in memory or a database. The system maintains a characteristic tag associated with the resource and its tracking device, and then displays a new kind of indicator different from the resource's original indicator that indicates the exposure. As the tracked resource continues moving, each time it comes within a certain distance of any other tracking device and meets specific requirements for exposure to the new resources, such as being with ten meters of a second resource for more than five minutes, then the second resource is also sent a notification of exposure, assuming no counter-indications for notification exist. The system could combine both of these tracked resources in the same monitoring session and record the time, location and other pertinent facts of the exposure and change the indicator of the second resource to indicate the exposure on the visual display. When recording an exposure, the system can also obtain from the tracking device and any associated sensors what pertinent information it can obtain, such as weather conditions to include temperature, humidity, time of day, week, month, season etc. and records this information with each exposure incident. The system could also record each “generation” of exposure and assign characteristic tags indicating this information to each tracking device. The resource that was originally contaminated being the zero generation, the resources exposed to that originally contaminated resource being first generation, those exposed to first generation being second generation, etc. The system can also record or calculate times between exposures, and between the original exposure and subsequent exposures, and record this information to calculate statistics about when each of these resources reports to a hospital and reports symptoms. These could be assigned to a mobile resource as characteristic tag.

The system can also identify a likely source of a spreading incident. This can be done such that information from tracked resources is ingested or otherwise inputted into the system, be it by uploading patient exposure data from hospitals, the CDC, or self-reports. The system then begins a monitoring session for each tracking device. The system can compare the monitoring session data history of the tracking devices to determine any commonalities, such eating at a specific restaurant, etc. Historical data from other tracking devices or task areas can be used to track down the source or sources of infection. The system can send alerts to those nearby devices.

The system can also determine where resources, such as first responders, should be sent to best address particular issues. The reporting device can calculate the epicenters of infection. Once one or more locations are determined, the system sends out notifications to dispatch the appropriate resources to those locations. The notifications can include tasks (e.g., instructions on specific actions to take), which the system can send out automatically or a user can enter manually. As resources are notified, the system adds them to monitoring session(s) and creates overlays with locations, activities and associated characteristic tags. Once resources arrive at locations, the system repeats the steps depending on any new information reported by the resources. These steps can be run iteratively, or as more resources become available. Alternatively, the system can release unneeded resources through notifications.

The instructions and/or data used in the practice of the invention may utilize any appropriate compression or encryption technique or algorithm, as may be desired. An encryption module might be used to encrypt data or the communications pathways used by the data. Further, files or other data may be decrypted using a suitable decryption module.

A system processing unit that executes commands and instructions may may utilize any of a wide variety of technologies including a computer, a microcomputer, mini-computer, mainframe computer, processor, CPU (Central Processing Unit), programmed micro-processor, micro-controller, peripheral integrated circuit element, a CSIC (Visitor Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

Location data can include the location of a tracking device. This can be expressed in any standard coordinate system such as by latitude and longitude, with or without elevation, MGRS coordinates, Cartesian coordinates, etc. Location data also can be expressed as relative data, such as X meters from a known location (such as the position of a cellular telephone tower), or relative data such as the tracking device has moved Y miles at an angle of ⊖ degrees from the its previous location, or relative to receiver, reader or other known location point.

Generally, it should be noted that the components depicted and described herein above may be, or include, a computer or multiple computers, transmitters and receivers. Although the components are shown as discrete units, all components may be interconnected or combined. The components may be described in the general context of computer-executable instructions, such as program modules, being executed by a computer. Generally, program modules include routines, programs, objects, applications, components, data structures, applets etc., that perform particular tasks or implement particular abstract data types. Appropriate computer-executable instructions, be they software, applets, computer code, program modules etc. implementing the function described above can be readily prepared by programmers of ordinary skill based on the teachings of the present disclosure, as will be appreciated by those skilled in the software art.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript, for example. Further, it is not necessary that a single type of instruction or programming language be utilized in conjunction with the operation of the system and method of the invention. Rather, any number of different programming languages may be utilized as is necessary or desirable.

In addition, the instructions and/or data used in the practice of the invention may utilize any compression or encryption technique or algorithm, as may be desired. An encryption module might be used to encrypt data. Further, files or other data may be decrypted using a suitable decryption module.

Those skilled in the art will appreciate that the invention may be practiced with various computer system configurations, including hand-held wireless devices such as mobile phones, tablets or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The processing unit that executes commands and instructions may be a general purpose computer, but may utilize any of a wide variety of other technologies including a special purpose computer, a microcomputer, mini-computer, mainframe computer, processor, CPU (Central Processing Unit), programmed micro-processor, micro-controller, peripheral integrated circuit element, a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It is appreciated that in order to practice the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. Input devices include those that recognize hand movements or gestures, such as in the case of gesture set supported by Android or the swipe movements recognized in iOS-based devices. These and other input devices are often connected to the processing unit through a user input interface that is coupled to the system bus, but may be connected by other interface and bus structures, such as a parallel port, game port or a universal serial bus (USB).

A user interface may include any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the invention, it is not necessary that a human user actually interact with a user interface used by the processing machine of the invention. Rather, it is also contemplated that the user interface of the invention might interact, i.e., convey and receive information, with another processing machine, rather than a human user. Further, it is contemplated that a user interface utilized in the invention may interact partially with another processing machine or processing machines, while also interacting partially with a human user.

Various networks may be implemented in accordance with embodiments of the invention, including a wired or wireless local area network (LAN) and a wide area network (WAN), the Internet, wireless personal area network (PAN) and other types of networks. When used in a LAN networking environment, computers or servers may be connected to the LAN through a network interface or adapter. When used in a WAN networking environment, computers typically include a modem or other communication mechanism. Modems may be internal or external, and may be connected to the system bus via the user-input interface, or other appropriate mechanism.

Computers and servers may be connected over the Internet, an Intranet, Extranet, Ethernet, or any other system that provides communications. Some suitable communications protocols may include TCP/IP, UDP, or OSI, for example. For wireless communications, communications protocols may include Bluetooth™, Zigbee, IrDa, Wi-Fi, 2G, 3G, Ultra-Wideband and Long Term Evolution (LTE) or other suitable protocols. The wireless communications protocol may also include short-range communications devices and protocols, such as RFID, or Near-Field Communication radio transmissions. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the server computer need not be disclosed in connection with the present invention.

The various embodiments and features of the presently disclosed invention may be used in any combination, as the combination of these embodiments and features are well within the scope of the invention. While the foregoing description includes many details and specificities, it is to be understood that these have been included for purposes of explanation only, and are not to be interpreted as limitations of the present invention. It will be apparent to those skilled in the art that other modifications to the embodiments described above can be made without departing from the spirit and scope of the invention. Accordingly, such modifications are considered within the scope of the invention as intended to be encompassed by the following claims and their legal equivalents.

What is claimed:

1. A mobile resource management system, comprising:
a server associated with a processor and a memory, and at least one tracking device, the server and the at least one tracking device capable of communicating with one another, and wherein the at least one tracking device is capable of communicating data comprising one or more characteristic tags associated with at least one mobile resource to the server during a monitoring session;
a reporting device to process data received from the at least one tracking device, wherein the reporting device is operable to generate a graphical display from the processed data by using at least one processor to execute computer-executable instructions to:
receive data from at least one of the server and the at least one tracking device,
generate a graphical display, wherein the graphical display includes a visual indicator that identifies the at least one mobile resource, the location of the at least one mobile resource on a map, and at least one characteristic tag associated with the at least one mobile resource, and
communicate the graphical display to a display unit;
a display unit operable to display the graphical display;
a task assignment engine, operable to communicate instructions to the at least one mobile resource via the at least one tracking device;
an alert generation engine, operable to generate alerts when predetermined criteria are satisfied based on the data, and communicate alerts to the at least one mobile resource via the at least one tracking device.

2. The system of claim 1, wherein the visual indicator comprises a symbol.

3. The system of claim 1, further comprising a monitoring session data storage unit addressable by the server, wherein the monitoring session data storage unit stores monitoring session data.

4. The system of claim 1, wherein alerts are generated when the tracking device is located outside of a predetermined location.

5. The system of claim 3, wherein monitoring session data comprises data from more than one tracking device.

6. The system of claim 1, wherein the visual indicator identifies at least two tracking devices.

7. The system of claim 1, further comprising a billing database comprising one or more billing rates associated with the at least one tracking device.

8. The system of claim 7, wherein the reporting device further comprises a billing engine in communication with the billing database operable to generate a resource cost from the processed data and one or more billing rates associated with the at least one tracking device.

9. The system of claim 1, further comprising a user input device.

10. The system of claim 3, further comprising a resource allocation engine operable to allocate mobile resources to a location based on the processed data and monitoring session data.

11. A resource management method, comprising the steps of:
tracking at least one mobile resource using a tracking device;
receiving, at a server during a monitoring session, data from the tracking device comprising at least location data and one or more characteristic tags;
generating on a reporting device a graphical display based on the data, wherein the graphical display includes at least one visual indicator that identifies the at least one mobile resource with a first symbol, the location of said mobile resource on a map, and at least one characteristic tag associated with the mobile resource;
identifying when the mobile resource comes within a certain distance of a predetermined location;
displaying the graphical display on a display device.

12. A resource management method, comprising the steps of:
tracking at least one mobile resource using at least one tracking device;
receiving, at a server during a monitoring session, data from the at least one tracking device, wherein the data comprises at least location data and one or more characteristic tags associated with the at least one tracking device;
generating a graphical display based on the data using a reporting device, wherein the graphical display includes visual indicators that identify the at least one mobile resource with a symbol, the location of said mobile resources on a map, and at least one characteristic tag;
identifying time spent by the at least one mobile resource at the location;
creating an overlay to be displayed on the map based on historical data.

13. A resource management method, comprising the steps of:
tracking multiple mobile resources using tracking devices;
receiving, at a server during a monitoring session, data from the tracking devices comprising at least location data and one or more characteristic tags;
generating on a reporting device a graphical display based on the data, wherein the graphical display includes at least visual indicators that identify the mobile resources symbols, the location of the mobile resources on a map, and at least one characteristic tag associated with each mobile resource, and displaying the graphical display on a display device;
identifying an event location requiring at least one mobile resource with at least one necessary characteristic tag;
identifying, based on the data, the mobile resource having the at least one characteristic tag matching the necessary characteristic tag located closest to the event location;
sending instructions to the mobile resource having the at least one characteristic tag matching the necessary characteristic tag comprising the event location.

14. A resource management method, comprising the steps of:
tracking at least one mobile resource using at least one tracking device;
receiving, at a server during a monitoring session, data from the at least one tracking device, wherein the data comprises at least location data and one or more characteristic tags associated with the at least one tracking device;
generating a graphical display based on the data using a reporting device, wherein the graphical display includes visual indicators that identify the at least one mobile resource with a symbol, the location of the mobile resources on a map, and at least one characteristic tag associated with the mobile resource;
identifying the amount of time spent by the at least one mobile resource at the location;
comparing the amount of time spent by the at least one mobile resource at the location to a predetermined amount of time.
